(19) United States
(12) Patent Application Publication
(10) Pub. No.: US 2006/0244569 A1
(43) Pub. Date: Nov. 2, 2006

(54) Tooth-borne radio-frequency medical read-write memory chip

(76) Inventors: Brian Gaetto, Darien, IL (US); Mary Ann Hollis, Oak Brook, IL (US); Robert Arrata, Torrance, CA (US)

Correspondence Address: Milton S. Gerstein;Much Shelist Freed, Suite 1800, 191 N. Wacker Drive, Chicago, IL, 60606, US

(21) Appl. No.: 11/363,458

(22) Filed: Feb. 27, 2006

Related U.S. Application Data
(60) Provisional application No. 60/657,315, filed on Feb. 28, 2005.

(51) Int. Cl. H04Q 5/22

(52) U.S. Cl. 340/10.51; 340/572.8

(57) ABSTRACT

A system and method for providing information about a user, where a wireless-transmitting read-write memory device for recording, storing and transmitting medical information is secured to a person's tooth. The medical Information comprises at least one of the user's past medical information; allergy Information, past surgical history Information, airway Issue information, anesthesia-related problem information, lab value information, baseline EKG information, physical examination Information, emergency contact information, insurance Information, date of birth, sex, height, weight and family history information.

### CROSS-REFERENCE TO RELATED APPLICATION

Priority of provisional application No. 60/657,315, filed on Feb. 28, 2005 is herewith claimed.

### BACKGROUND OF THE INVENTION

The present invention is directed to a medical radio-frequency memory chip that contains pertinent, relevant or critical medical information about a person.

There presently exist smart cards that carry medical information about a person, which medical information may be critical to the person's health if he were experience a medical emergency. Such information may contain information about a medicine or food to which he or she is allergic, current drugs he or she is taking and dosages thereof, medical condition that a doctor or hospital should be aware of. Examples of these prior-art medical-warning smart cards and systems are those sold by the following companies: Redmedic, Med-Info Chip, Passport MD, Follow Me, and Medical Emergency Data Systems.

It is also known to use location-sensing RFID chips for informing of the whereabouts of an object. One such example is disclosed in U.S. Pat. No. 6,734,795, where an RFID chip is implanted in a portion of dentures for providing continual tracking of the dentures in the case they become lost.

### SUMMARY OF THE INVENTION

It is the primary objective of the present invention to provide an RF read-write chip that is attached or otherwise mounted to a tooth of a person, which chip contains critical medical information about the person.

In the preferred embodiment, a wireless-transmitting memory chip is affixed to the tooth of the person, as by bonding, implanting or as a part of an overall crown. The memory chip or tag stores medical information about the user, such as past medical information, allergy information, past surgical history information, medication information, airway issue information, anesthesia-related problem information, lab value information, baseline EKG information, physical examination information, emergency contact information, insurance information, date of birth, sex, height, weight and family history information, and the like.

### BRIEF DESCRIPTION OF THE DRAWINGS

The invention will be more readily understood with reference to the accompanying drawings, wherein:

FIG. 1 depicts a schematic illustration of a system in accordance with the present invention; and

FIG. 2 is a flow diagram depicting a method of providing information about a user.

### DETAILED DESCRIPTION OF THE INVENTION

The present invention uses a RF tag or chip manufactured by InsideContacless, Inc. of France, and, in particular the IC 215H radio frequency tag in the size of 6×6 mm. These tags are unique in that they are both readable and writable. Owing to the small size thereof, and in accordance with the present invention, they are secured to a tooth of a person for bearing important medical history of the person. A tag is secured to the tooth of person by conventional techniques, such as by bonding, which is achieved by applying a mild etching solution to the enamel structure of the user's tooth that create small crevices. These small crevices provide a slightly rough surface. The RF chip or tag is then placed in the etched-out surface, and one or more layers of a durable resin are then applied to the user's tooth. High-intensity UV radiation cures the resin, affixing the tag to the user's tooth. The F chip is encased in a protective casing, such as zirconium oxide or artglass, in order to protect the chip from the oral-cavity environment and also to protect the oral cavity from the electric circuitry of the chip. The chip may also be secured to the tooth as an implant or as part of a crown in a conventional manner.

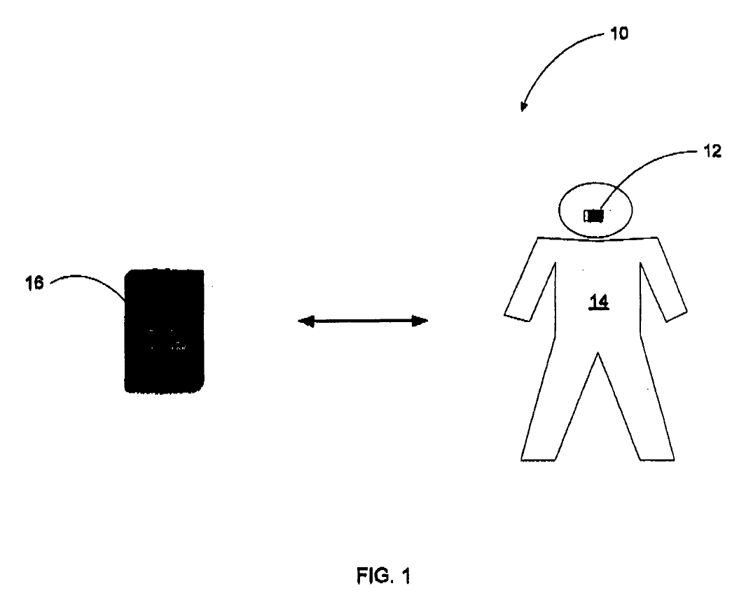

Referring now to FIG. 1, one exemplary embodiment of a system for providing medical information about a user is illustrated. More specifically, FIG. 1 depicts a system, generally designated 10, for storing and transmitting information about a user 14. The system 10 comprises a read-write RF memory device 12, such as above-described IC 215H radio frequency tag in the size of 6×6 mm. sold by InsideContactless, Inc. of France, which is secured to a tooth of the user by any of the above-mentioned conventional securing techniques. A scanner or proximity reader 16 is adapted to read out or receive the medical information as well as to write it to the chip 12.

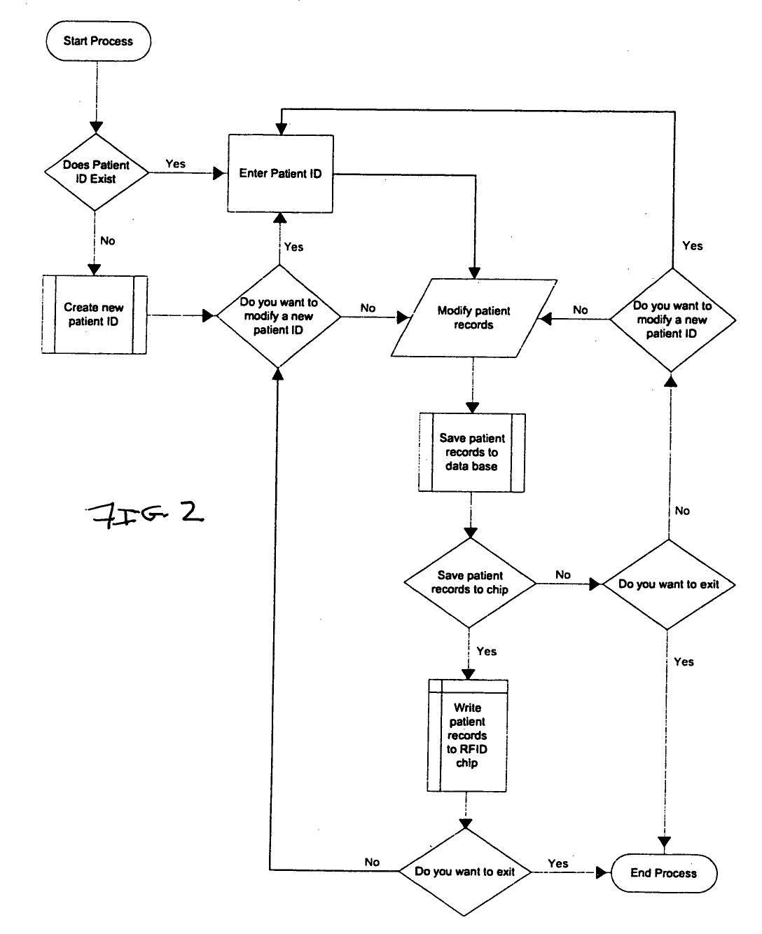

Referring to FIG. 2, there is shown the flow chart for storing the medical information in the RF tag 12. Owing to the unique characteristics of the RF chip used in the present invention: To wit: minute size for attachment to a tooth and its read-write capability, the software of the present invention allows the medical information on the tooth-borne tag to be continually updated. In decision block 20, the software determines if the patient presently has an ID. If “YES”, then that patient's ID is entered (block 22) and his medical information retrieved. The software then modifies the patient records with the new information (block 24), and saves it to the data base (block 26). In decision block 28, the program determines if the new revised medical information is to be saved. If “YES”, the program proceeds to wirelessly write the revised medical information to the RF chip 12 (block 30). If the answer to decision block 28 is “NO”, or after the revised medical information has been written to chip, the program exits if no additional patient records need modification (decision blocks 32, 34) or if that patient's record needs to be revised further (“NO” to decision block 28 and “YES” to decision block 34). If further modification of that patient's medical record is required, then the program proceeds to do so (“NO” to decision blocks 32 and 36, or decision blocks 34 38) and writes that additional modification to the chip 12 as before (blocks 24-30). If a different patient's medical records is to be modified (“YES” to decision blocks 36, 38), then the new patient's ID is entered (block 22) and his medical records retrieved and then modified, with the modified records written to the tag 12 as described above for blocks 24-38. For a new patient that is having his medical records developed for the first time, the software creates a new patient ID for him (block 40), and proceeds to write the tag for him in the manner described above for blocks 24-38, with the answer to decision block 36 being “NO”. All read/write operations are done in the conventional manner via radio frequency using, for example, InsideContactiess' Proximity Kit. The tag 12 may be a very small EEPROM or flash memory, or the equivalents thereof, as long as it has the capability of being erasable and written thereof; that is, as long as it has read-write capabilities. In addition, ISO 15693 standard systems, besides ISO 144430 standard systems, may be used in order to increase the read/write distance between the tag and the reader/writer.

The chip 12 contains user information such as, allergy information, past surgical history, other medication information, airway issue information, anesthesia-related problem information, lab value information, baseline EKG information, physical examination information, emergency contact information, insurance information, date of birth, sex, height, weight and family history information. It is further contemplated that the chip 12 may contain the user's DNA signature or other confirmation device, confirming that the information stored on the chip is that of the user and has not been duplicated or stolen.

While the invention has been described with reference to certain embodiments, it will be understood by those skilled in the art that various changes may be made and equivalents may be substituted without departing from the scope of the invention. For example, the RF tag may be used as part of a wireless telephone device (as a wireless transmitter for example) or as part of a transmitter or receiver for the hearing impaired. Further, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

The following is a listing of the software code for carrying out the invention.

```
<?xml version=“1.0” encoding=“utf-8”?>
<asmv1:assembly xsi:schemaLocation=“urn:schemas-microsoft-com:asm.v1
assembly.adaptive.xsd” manifestVersion=“1.0”
xmlns:dsig=“http://www.w3.org/2000/09/xmldsig#” xmlns=“urn:schemas-microsoft-
com:asm.v2” xmlns:asmv1=“urn:schemas-microsoft-com:asm.v1”
xmlns:asmv2=“urn:schemas-microsoft-com:asm.v2”
xmlns:xrml=“urn:mpeg:mpeg21:2003:01-REL-R-NS”
xmlns:xsi=“http://www.w3.org/2001/XMLSchema-instance”>
    <assemblyIdentity name=“Tooth Ferry.application” version=“1.0.3.0”
publicKeyToken=“6330b9f96e1e8647” language=“neutral”
processorArchitecture=“msil” xmlns=“urn:schemas-microsoft-com:asm.v1” />
    <description asmv2:publisher=“Tooth Ferry” asmv2:product=“Tooth Ferry”
xmlns=“urn:schemas-microsoft-com:asm.v1” />
    <deployment install=“true” mapFileExtensions=“true” />
    <dependency>
        <dependentAssembly dependencyType=“install” allowDelayedBinding=“true”
codebase=“Tooth Ferry_1_0_3_0\Tooth Ferry.exe.manifest” size=“5563”>
            <assemblyIdentity name=“Tooth Ferry.exe” version=“1.0.3.0”
publicKeyToken=“6330b9f96e1e8647” language=“neutral”
processorArchitecture=“msil” type=“win32” />
            <hash>
                <dsig:Transforms>
                    <dsig:Transform Algorithm=“urn:schemas-microsoft-
com:HashTransforms.Identity” />
                </dsig:Transforms>
                <dsig:DigestMethod Algorithm=“http://www.w3.org/2000/09/xmldsig#sha1”
/>
                <dsig:DigestValue>v2zbBzQp4OqTxWE6RaSx6hAWgCM=</dsig:DigestValue>
            </hash>
        </dependentAssembly>
    </dependency>
</asmv1:assembly>
<?xml version=“1.0” encoding=“utf-8”?>
<asmv1:assembly xsi:schemaLocation=“urn:schemas-microsoft-com:asm.v1
assembly.adaptive.xsd” manifestVersion=“1.0”
xmlns:dsig=“http://www.w3.org/2000/09/xmldsig#” xmlns=“urn:schemas-microsoft-
com:asm.v2” xmlns:asmv1=“urn:schemas-microsoft-com:asm.v1”
xmlns:asmv2=“urn:schemas-microsoft-com:asm.v2”
xmlns:xrm1=“urn:mpeg:mpeg21:2003:01-REL-R-NS”
xmlns:xsi=“http://www.w3.org/2001/XMLSchema-instance”>
    <assemblyIdentity name=“Tooth Ferry.application” version=“1.0.3.1”
publicKeyToken=“6330b9f96e1e8647” language=“neutral”
processorArchitecture=“msil” xmlns=“urn:schemas-microsoft-com:asm.v1” />
    <description asmv2:publisher=“Tooth Ferry” asmv2:product=“Tooth Ferry”
xmlns=“urn:schemas-microsoft-com:asm.v1” />
    <deployment install=“true” mapFileExtensions=“true” />
    <dependency>
        <dependentAssembly dependencyType=“install” allowDelayedBinding=“true”
codebase=“Tooth Ferry_1_0_3_1\Tooth Ferry.exe.manifest” size=“5563”>
            <assemblyIdentity name=“Tooth Ferry.exe” version=“1.0.3.1”
publicKeyToken=“6330b9f96e1e8647” language=“neutral”
processorArchitecture=“msil” type=“win32” />
            <hash>
                <dsig:Transforms>
                    <dsig:Transform Algorithm=“urn:schemas-microsoft-
com:HashTransforms.Identity” />
                </dsig:Transforms>
                <dsig:DigestMethod Algorithm=“http://www.w3.org/2000/09/xmldsig#sha1”
/>
                <dsig:DigestValue>XYLxZMuPmYLFGQa8IX92R/dApK4=</dsig:DigestValue>
            </hash>
        </dependentAssembly>
    </dependency>
</asmv1:assembly>
<?xml version=“1.0” encoding=“utf-8”?>
<asmv1:assembly xsi:schemaLocation=“urn:schemas-microsoft-com:asm.v1
assembly.adaptive.xsd” manifestVersion=“1.0”
xmlns:dsig=“http://www.w3.org/2000/09/xmldsig#” xmlns=“urn:schemas-microsoft-
com:asm.v2” xmlns:asmv1=“urn:schemas-microsoft-com:asm.v1”
xmlns:asmv2=“urn:schemas-microsoft-com:asm.v2”
xmlns:xrml=“urn:mpeg:mpeg21:2003:01-REL-R-NS”
xmlns:xsi=“http://www.w3.org/2001/XMLSchema-instance”>
    <assemblyIdentity name=“Tooth Ferry.application” version=“1.0.3.2”
publicKeyToken=“6330b9f96e1e8647” language=“en” processorArchitecture=“msil”
xmlns=“urn:schemas-microsoft-com:asm.v1” />
    <description asmv2:publisher=“Michael H. Blanchard” asmv2:product=“Tooth
Ferry Demonstration Interface” xmlns=“urn:schemas-microsoft-com:asm.v1” />
    <deployment install=“true” mapFileExtensions=“true” />
    <dependency>
        <dependentAssembly dependencyType=“install” allowDelayedBinding=“true”
codebase=“Tooth Ferry_1_0_3_2\Tooth Ferry.exe.manifest” size=“5694”>
            <assemblyIdentity name=“Tooth Ferry.exe” version=“1.0.3.2”
publicKeyToken=“6330b9f96e1e8647” language=“en” processorArchitecture=“msil”
type=“win32” />
            <hash>
                <dsig:Transforms>
                    <dsig:Transform Algorithm=“urn:schemas-microsoft-
com:HashTransforms.Identity” />
                </dsig:Transforms>
                <dsig:DigestMethod Algorithm=“http://www.w3.org/2000/09/xmldsig#sha1”
/>
                <dsig:DigestValue>e58MFsIzU+jWBtTNREkmFIWfe7Q=</dsig:DigestValue>
            </hash>
        </dependentAssembly>
    </dependency>
</asmv1:assembly>
<?xml version=“1.0” encoding=“utf-8”?>
<asmv1:assembly xsi:schemaLocation=“urn:schemas-microsoft-com:asm.v1
assembly.adaptive.xsd” manifestVersion=“1.0”
xmlns:dsig=“http://www.w3.org/2000/09/xmldsig#” xmlns=“urn:schemas-microsoft-
com:asm.v2” xmlns:asmv1=“urn:schemas-microsoft-com:asm.v1”
xmlns:asmv2=“urn:schemas-microsoft-com:asm.v2”
xmlns:xrml=“urn:mpeg:mpeg21:2003:01-REL-R-NS”
xmlns:xsi=“http://www.w3.org/2001/XMLSchema-instance”>
    <assemblyIdentity name=“Tooth_Ferry.application” version=“1.0.3.3”
publicKeyToken=“6330b9f96e1e8647” language=“en” processorArchitecture=“msil”
xmlns=“urn:schemas-microsoft-com:asm.v1” />
    <description asmv2:publisher=“Michael H. Blanchard” asmv2:product=“Tooth
Ferry Demonstration Interface” xmlns=“urn:schemas-microsoft-com:asm.v1” />
    <deployment install=“true” mapFileExtensions=“true” />
    <dependency>
        <dependentAssembly dependencyType=“install” allowDelayedBinding=“true”
codebase=“Tooth_Ferry_1_0_3_3\Tooth_Ferry.exe.manifest” size=“9517”>
            <assemblyIdentity name=“Tooth_Ferry.exe” version=“1.0.3.3”
publicKeyToken=“6330b9f96e1e8647” language=“en” processorArchitecture=“msil”
type=“win32” />
            <hash>
                <dsig:Transforms>
                    <dsig:Transform Algorithm=“urn:schemas-microsoft-
com:HashTransforms.Identity” />
                </dsig:Transforms>
                <dsig:DigestMethod Algorithm=“http://www.w3.org/2000/09/xmldsig#shal”
/>
                <dsig:DigestValue>NWSai6dbB+5idxfFS/FdWsIR4Ac=</dsig:DigestValue>
            </hash>
        </dependentAssembly>
    </dependency>
<Signature Id=“StrongNameSignature”
xmlns=“http://www.w3.org/2000/09/xmldsig#”><SignedInfo><CanonicalizationMethod
Algorithm=“http://www.w3.org/2001/10/xml-exc-c14n#” /><SignatureMethod
Algorithm=“http://www.w3.org/2000/09/xmldsig#rsa-shal” /><Reference
URI=“”><Transforms><Transform
Algorithm=“http://www.w3.org/2000/09/xmldsig#enveloped-signature”
/><Transform Algorithm=“http://www.w3.org/2001/10/xml-exc-c14n#”
/></Transforms><DigestMethod
Algorithm=“http://www.w3.org/2000/09/xmldsig#shal”
/><DigestValue>S6kHRDgWGWty/98Pwc3ZndD9n1w=</DigestValue></Reference><Reference
URI=“#StrongNameKeyInfo”><Transforms><Transform
Algorithm=“http://www.w3.org/2001/10/xml-exc-c14n#”
/></Transforms><DigestMethod
Algorithm=“http://www.w3.org/2000/09/xmldsig#shal”
/><DigestValue>4cPK069NmJ8eTn9ZXE51hw3WdAg=</DigestValue></Reference></Signed
Info><SignatureValue>LxNC5c8KoXlHg0NPzyavSr6A0gRVUrmUnrJAX/FWyYdfs9CzzAkwGdp4
QHCTLR8TYcQ1Lk8zUA8+dwLOUd13ic8QHKyVryCG9eJCjp/KHMgc8QquZ8LI0YYWdorXsPtOSJ44+
4M4zuI5TveETgc8vxar5citP5v8tL7rdsfqYps=</SignatureValue><KeyInfo
Id=“StrongNameKeyInfo”><KeyValue><RSAKeyValue><Modulus>qegkjXEG7IIat9mIoYVk8J
15XZOpkoc6cxEG58g581eXiquaF0hyLZ87t8AahnJZ2SrpoWjytx9eR8hZSRNTIX0v0ICjrx1GDA7
R7REkn8+IgOMLoMmnRn6z3sljQj2/XKtqijfXnQFiNU7a26OmCI6OkUZj0eIUN2P1RvIJ1Bs=</Modulus
><Exponent>AQAB</Exponent></RSAKeyValue></KeyValue><msrel:RelData
xmlns:msrel=“http://schemas.microsoft.com/windows/rel/2005/reldata”><r:license
xmlns:r=“urn:mpeg:mpeg21:2003:01-REL-R-NS”
xmlns:as=“http://schemas.microsoft.com/windows/pki/2005/Authenticode”><r:grant
><as:ManifestInformation Hash=“d0adeb1c50238ff2c1d93140bdfab3eb4939821f”
Description=“” Url=“”><as:assemblyIdentity name=“Tooth_Ferry.application”
version=“1.0.3.3” publicKeyToken=“6330b9f96e1e8647” language=“en”
processorArchitecture=“msil” xmlns=“urn:schemas-microsoft-com:asm.v1”
/></as:ManifestInformation><as:SignedBy
/><as:AuthenticodePublisher><as:X509SubjectName>CN=HQBCI2000\BlanchardK</as:X
509SubjectName></as:Authenticodepublisher></r:grant><r:issuer><Signature
Id=“AuthenticodeSignature”
xmlns=“http://www.w3.org/2000/09/xmldsig#”><SignedInfo><CanonicalizationMethod
Algorithm=“http://www.w3.org/2001/10/xml-exc-c14n#” /><SignatureMethod
Algorithm=“http://www.w3.org/2000/09/xmldsig#rsa-shal” /><Reference
URI=“”><Transforms><Transform
Algorithm=“http://www.w3.org/2000/09/xmldsig#enveloped-signature”
/><Transform Algorithm=“http://www.w3.org/2001/10/xml-exc-c14n#”
/></Transforms><DigestMethod
Algorithm=“http://www.w3.org/2000/09/xmldsig#shal”
/><DigestValue>KEtpJczFOHCQ3qgYGBnSAoNHf3A=</DigestValue></Reference></Signed
Info><SignatureValue>F3WQnTHsB+g9nYeL1LuXNZh81HdyWyk90EnmLhU00DOhnZLHdfKwZejZ
TeVAGh3FbcrygVOF41BDJiD3S2ZIkKsRRR/HyH3HOO76gNsKd0YIuP1YS1SrezhLQKXy/UtFLBB45
wnz1gdHM72WAIZ4FGbRHx2hIrWbAel6gla13Eo=</SignatureValue><KeyInfo><KeyValue><R
SAKeyValue><Modulus>qegkjXEG7IIat9mIoYVk8Jl5XZOpkoc6cxEG58g581eXiquaF0hyLZ87t
8AahnJZ2SrpoWjytx9eR8hZSRNTIX0v0ICjrx1GDA7R7REkn8+IgOMLoMmnRn6z3sljQj2/XKtqij
fXnQFiNU7a26OmCI6OkUZj0eIUN2P1RvIJ1Bs=</Modulus><Exponent>AQAB</Exponent></RS
AKeyValue></KeyValue><X509Data><X509Certificate>MIIB4TCCAU6gAwIBAgIQaBZ0f4f4b
LVJYraTZ9Y1izAJBgUrDgMCHQUAMDMxMTAvBgNVBAMeKABIAFEAQgBDAEkAMgAwADAAMABcAEIAbA
BhAG4AYwBoAGEAcgBkAEswHhcNMDUwOTIxMDQ1MDAzWhcNMDYwOTIxMTA1MDAzWjAzMTEwLwYDVQQ
DHigASABRAEIAQWBJADIAMAAwADAAXABCAGwAYQBuAGMAaABhAHIAZABLMIGfMA0GCSqGSIb3DQEB
AQUAA4GNADCBiQKBgQCp6CSNcQbsghq32YihhWTWmX1dk6mShzpzEQbnyDnzV5eKq5oXSHItnzu3w
BqGclnZKumhaPK3H15HyFlJE1MhfS/QgKOvHUYMDtHtESSfz4iA4wugyadGfrPeyWNCPb9cq2qKN9
edAWI1Ttrbo6YIjo6RRmPR4hQ3Y/VG8gnUGwIDAQABMAkGBSsOAwIdBQADgYEAeccefLeuoPEh9KP
N1GmdKOEP6P7QblvdDJ8SwTI2qsW/crZcqun4pBJNsscusvYdGpoDOR8IuIHh6NOjzhQ2X4vl3sJE
HUro9HO0OmSvtlIhzhxnBVUL63Kht0BwGZjg9e4+PnJupBoTk5YysVsG4afUwjr0SCZaEkspMguXd
1E=</X509Certificate></X509Data></KeyInfo></Signature></r:issuer></r:license>
</msrel:RelData></KeyInfo></Signature></asmv1:assembly>
<?xml version=“1.0” encoding=“utf-8”?>
<asmv1:assembly xsi:schemaLocation=“urn:schemas-microsoft-com:asm.v1
assembly.adaptive.xsd” manifestVersion=“1.0”
xmlns:dsig=“http://www.w3.org/2000/09/xmldsig#” xmlns=“urn:schemas-microsoft-
com:asm.v2” xmlns:asmv1=“urn:schemas-microsoft-com:asm.v1”
xmlns:asmv2=“urn:schemas-microsoft-com:asm.v2”
xmlns:xrml=“urn:mpeg:mpeg21:2003:01-REL-R-NS”
xmlns:xsi=“http://www.w3.org/2001/XMLSchema-instance”>
    <assemblyIdentity name=“Tooth_Ferry.application” version=“1.0.3.4”
publicKeyToken=“6330b9f96e1e8647” language=“en” processorArchitecture=“msil”
xmlns=“urn:schemas-microsoft-com:asm.v1” />
    <description asmv2:publisher=“Michael H. Blanchard” asmv2:product=“Tooth
Ferry Demonstration Interface” xmlns=“urn:schemas-microsoft-com:asm.v1” />
    <deployment install=“true” mapFileExtensions=“true” />
    <dependency>
        <dependentAssembly dependencyType=“install” allowDelayedBinding=“true”
codebase=“Tooth_Ferry_1_0_3_4\ToothFerry.exe.manifest” size=“9880”>
            <assemblyIdentity name=“Tooth_Ferry.exe” version=“1.0.3.4”
publicKeyToken=“6330b9f96e1e8647” language=“en” processorArchitecture=“msil”
type=“win32” />
            <hash>
                <dsig:Transforms>
                    <dsig:Transform Algorithm=“urn:schemas-microsoft-
com:HashTransforms.Identity” />
                </dsig:Transforms>
                <dsig:DigestMethod Algorithm=“http://www.w3.org/2000/09/xmldsig#shal”
/>
                <dsig:DigestValue>6rjMZNIFpkS1DzmgKMinmk7EcXY=</dsig:DigestValue>
            </hash>
        </dependentAssembly>
    </dependency>
<Signature Id=“StrongNameSignature”
xmlns=“http://www.w3.org/2000/09/xmldsig#”><SignedInfo><CanonicalizationMethod
Algorithm=“http://www.w3.org/2001/10/xml-exc-c14n#” /><SignatureMethod
Algorithm=“http://www.w3.org/2000/09/xmldsig#rsa-sha1” /><Reference
URI=“”><Transforms><Transform
Algorithm=“http://www.w3.org/2000/09/xmldsig#enveloped-signature”
/><Transform Algorithm=“http://www.w3.org/2001/10/xml-exc-c14n#”
/></Transforms><DigestMethod
Algorithm=“http://www.w3.org/2000/09/xmldsig#sha1”
/><DigestValue>mbvxZ2/eZMyu31gpUVFDmCsrO5s=</DigestValue></Reference><Reference
URI=“#StrongNameKeyInfo”><Transforms><Transform
Algorithm=“http://www.w3.org/2001/10/xml-exc-c14n#”
/></Transforms><DigestMethod
Algorithm=“http://www.w3.org/2000/09/xmldsig#sha1”
/><DigestValue>X/L7J7DVbXqAkfAAcTHSpkbwfYU=</DigestValue></Reference></Signed
Info><SignatureValue>j8pdHzOJVE1y2AgrOQsAf5rEysFc5CI46q2oOpB8oByz9sV+AU7GW16T
RtrRDsH4R/rTL5exXUEC8nfy6KOZJ+vnd5/Ib0UbfGdPAZaX+PHni4kLswdChJQE3etlIn0loBaeh
UTFLXS2Uh+p0BFDSiy3vqb4HctCu99jp6NF5y8=</SignatureValue><KeyInfo
Id=“StrongNameKeyInfo”><KeyValue><RSAKeyValue><Modulus>qegkjXEG7IIat9mIoYVk8J
15XZOpkoc6cxEG58g581eXiquaF0hyLZ87t8AahnJZ2SrpoWjytx9eR8hZSRNTIX0v0ICjrx1GDA7
R7REkn8+IgOMLoMmnRn6z3sljQj2/XKtqijfXnQFiNU7a26OmCI6OkUZj0eIUN2P1RvIJ1Bs=</Modulus>
<Exponent>AQAB</Exponent></RSAKeyValue></KeyValue><msrel:RelData
xmlns:msrel=“http://schemas.microsoft.com/windows/rel/2005/reldata”><r:license
xmlns:r=“urn:mpeg:mpeg21:2003:01-REL-R-NS”
xmlns:as=“http://schemas.microsoft.com/windows/pki/2005/Authenticode”><r:grant>
<as:ManifestInformation Hash=“5841394ce65f5535d8134ddbb27b2334e03b8f11”
Description=“” Url=“”><as:assemblyIdentity name=“Tooth_Ferry.application”
version=“1.0.3.4” publicKeyToken=“6330b9f96e1e8647” language=“en”
processorArchitecture=“msil” xmlns=“urn:schemas-microsoft-com:asm.v1”
/></as:ManifestInformation><as:SignedBy
/><as:AuthenticodePublisher><as:X509SubjectName>CN=HQBCI2000\BlanchardK</as:X
509SubjectName></as:AuthenticodePublisher></r:grant><r:issuer><Signature
Id=“AuthenticodeSignature”
xmlns=“http://www.w3.org/2000/09/xmldsig#”><SignedInfo><CanonicalizationMethod
Algorithm=“http://www.w3.org/2001/10/xml-exc-c14n#” /><SignatureMethod
Algorithm=“http://www.w3.org/2000/09/xmldsig#rsa-sha1” /><Reference
URI=“”><Transforms><Transform
Algorithm=“http://www.w3.org/2000/09/xmldsig#enveloped-signature”
/><Transform Algorithm=“http://www.w3.org/2001/10/xml-exc-c14n#”
/></Transforms><DigestMethod
Algorithm=“http://www.w3.org/2000/09/xmldsig#sha1”
/><DigestValue>pkvb4XwiZQxOnuxM4AdLssHDSVg=</DigestValue></Reference></Signed
Info><SignatureValue>an+E413sMTw9Yh6tB3Pf0oFaFi6OMxIV0SNqT1/nfDt0ls6K7d5zQZXX
bHC7ZQPsOKaSGH2TRCps17IQ20gc1wrZmkfg/eiNrY7sZz+IVqI+JADRgZ7p5z7wI/m6sW+Thvz3u
3M5vm1NgDFu2b2GstNJauxq96CQzPQBhKMlNdY=</SignatureValue><KeyInfo><KeyValue><RSA
KeyValue><Modulus>qegkjXEG7IIat9mIoYVk8J15XZOpkoc6cxEG58g581eXiquaF0hyLZ87t
8AahnJZ2SrpoWjytx9eR8hZSRNTIX0v0ICjrx1GDA7R7REkn8+IgOMLoMmnRn6z3sljQj2/XKtqij
fXnQFiNU7a26OmCI6OkUZj0eIUN2P1RvIJ1Bs=</Modulus><Exponent>AQAB</Exponent></RSA
KeyValue></KeyValue><X509Data><X509Certificate>MIIB4TCCAU6gAwIBAgIQaBZ0f4f4b
LVJYraTZ9Y1izAJBgUrDgMCHQUAMDMxMTAvBgNVBAMeKABIAFEAQgBDAEkAMgAwADAAMABcAEIAbA
BhAG4AYwBoAGEAcgBkAEswHhcNMDUwOTIxMDQ1MDAzWhcNMDYwOTIxMTA1MDAzWjAzMTEwLwYDVQQ
DHigASABRAEIAQwBJADIAMAAwADAAXABCAGwAYQBuAGMAaABhAHIAZABLMIGfMA0GCSqGSIb3DQEB
AQUAA4GNADCBiQKBgQCp6CSNcQbsghq32YihhWTwmXldk6mShzpzEQbnyDnzV5eKq5oXSHItnzu3w
BqGclnZKumhaPK3H15HyFlJE1MhfS/QgKOvHUYMDtHtESSfz4iA4wugyadGfrPeyWNCPb9cq2qKN9
edAWI1Ttrbo6YIjo6RRmPR4hQ3Y/VG8gnUGwIDAQABMAkGBSsOAwIdBQADgYEAeccefLeuoPEh9KP
N1GmdKOEP6P7QblvdDJ8SwTI2qsW/crZcqun4pBJNsscUsvYdGpoDOR8IuIHh6NOjzhQ2X4vl3sJE
HUro9HO0OmSvtlIhzhxnBVUL63Kht0BwGZjg9e4+PnJupBoTk5YysVsG4afUwjr0SCZaEkspMguXd
1E=</X509Certificate></X509Data></KeyInfo></Signature></r:issuer></r:license>
</msrel:RelData></KeyInfo></Signature></asmv1:assembly>
<?xml version=“1.0” encoding=“utf-8”?>
<asmv1:assembly xsi:schemaLocation=“urn:schemas-microsoft-com:asm.v1
assembly.adaptive.xsd” manifestVersion=“1.0”
xmlns:dsig=“http://www.w3.org/2000/09/xmldsig#” xmlns=“urn:schemas-microsoft-
com:asm.v2” xmlns:asmv1=“urn:schemas-microsoft-com:asm.v1”
xmlns:asmv2=“urn:schemas-microsoft-com:asm.v2”
xmlns:xrml=“urn:mpeg:mpeg21:2003:01-REL-R-NS”
xmlns:xsi=“http://www.w3.org/2001/XMLSchema-instance”>
    <assemblyIdentity name=“Tooth Ferry.application” version=“1.0.3.2”
publicKeyToken=“6330b9f96e1e8647” language=“en” processorArchitecture=“msil”
xmlns=“urn:schemas-microsoft-com:asm.v1” />
    <description asmv2:publisher=“Michael H. Blanchard” asmv2:product=“Tooth
Ferry Demonstration Interface” xmlns=“urn:schemas-microsoft-com:asm.v1” />
    <deployment install=“true” mapFileExtensions=“true” />
    <dependency>
        <dependentAssembly dependencyType=“install” allowDelayedBinding=“true”
codebase=“Tooth_Ferry_1_0_3_4\Tooth_Ferry.exe.manifest” size=“9880”>
            <assemblyIdentity name=“Tooth_Ferry.exe” version=“1.0.3.4”
publicKeyToken=“6330b9f96e1e8647” language=“en” processorArchitecture=“msil”
type=“win32” />
            <hash>
                <dsig:Transforms>
                    <dsig:Transform Algorithm=“urn:schemas-microsoft-
com:HashTransforms.Identity” />
                </dsig:Transforms>
                <dsig:DigestMethod Algorithm=“http://www.w3.org/2000/09/xmldsig#sha1”
/>
                <dsig:DigestValue>6rjMZNIFpks1DzmgKMinmk7EcXY=</dsig:DigestValue>
            </hash>
        </dependentAssembly>
    </dependency>
</asmv1:assembly>
<?xml version=“1.0” encoding=“utf-8”?>
<asmv1:assembly xsi:schemaLocation=“urn:schemas-microsoft-com:asm.v1
assembly.adaptive.xsd” manifestVersion=“1.0”
xmlns:dsig=“http://www.w3.org/2000/09/xmldsig#” xmlns=“urn:schemas-microsoft-
com:asm.v2” xmlns:asmv1=“urn:schemas-microsoft-com:asm.v1”
xmlns:asmv2=“urn:schemas-microsoft-com:asm.v2”
xmlns:xrml=“urn:mpeg:mpeg21:2003:01-REL-R-NS”
xmlns:xsi=“http://www.w3.org/2001/XMLSchema-instance”>
    <assemblyIdentity name=“Tooth_Ferry.application” version=“1.0.3.4”
publicKeyToken=“6330b9f96e1e8647” language=“en” processorArchitecture=“msil”
xmlns=“urn:schemas-microsoft-com:asm.v1” />
    <description asmv2:publisher=“Michael H. Blanchard” asmv2:product=“Tooth
Ferry Demonstration Interface” xmlns=“urn:schemas-microsoft-com:asm.v1” />
    <deployment install=“true” mapFileExtensions=“true” />
    <dependency>
        <dependentAssembly dependencyType=“install” allowDelayedBinding=“true”
codebase=“Tooth_Ferry_1_0_3_4\Tooth_Ferry.exe.manifest” size=“9880”>
            <assemblyIdentity name=“Tooth_Ferry.exe” version=“1.0.3.4”
publicKeyToken=“6330b9f96e1e8647” language=“en” processorArchitecture=“msil”
type=“win32” />
            <hash>
                <dsig:Transforms>
                    <dsig:Transform Algorithm=“urn:schemas-microsoft-
com:HashTransforms.Identity” />
                </dsig:Transforms>
                <dsig:DigestMethod Algorithm=“http://www.w3.org/2000/09/xmldsig#sha1”
/>
                <dsig:DigestValue>6rjMZNIFpks1DzmgKMinmk7EcXY=</dsig:DigestValue>
            </hash>
        </dependentAssembly>
    </dependency>
<Signature Id=“StrongNameSignature”
xmlns=“http://www.w3.org/2000/09/xmldsig#”><SignedInfo><CanonicalizationMethod
Algorithm=“http://www.w3.org/2001/10/xml-exc-c14n#” /><SignatureMethod
Algorithm=“http://www.w3.org/2000/09/xmldsig#rsa-sha1” /><Reference
URI=“”><Transforms><Transform
Algorithm=“http://www.w3.org/2000/09/xmldsig#enveloped-signature”
/><Transform Algorithm=“http://www.w3.org/2001/10/xml-exc-c14n#”
/></Transforms><DigestMethod
Algorithm=“http://www.w3.org/2000/09/xmldsig#sha1”
/><DigestValue>mbvxZ2/eZMyu31gpUVFDmCsrO5s=</DigestValue></Reference><Reference
URI=“#StrongNameKeyInfo”><Transforms><Transform
Algorithm=“http://www.w3.org/2001/10/xml-exc-c14n#”
/></Transforms><DigestMethod
Algorithm=“http://www.w3.org/2000/09/xmldsig#sha1”
/><DigestValue>X/L7J7DVbXqAkfAAcTHSpkbwfYU=</DigestValue></Reference></Signed
Info><SignatureValue>j8pdHzOJVE1y2AgrOQsAf5rEysFc5CI46q2oOpB8oByz9sV+AU7GW16T
RtrRDsH4R/rTL5exXUEC8nfy6KOZJ+vnd5/Ib0UbfGdPAZaX+PHni4kLswdChJQE3etlIn01oBaeh
UTFLXS2Uh+p0BFDSiy3vqb4HctCu99jp6NF5y8=</SignatureValue><KeyInfo
Id=“StrongNameKeyInfo”><KeyValue><RSAKeyValue><Modulus>qegkjXEG7IIat9mIoYVk8J
15XZOpkoc6cxEG58g581eXiquaF0hyLZ87t8AahnJZ2SrpoWjytx9eR8hZSRNTIX0v0ICjrx1GDA7
R7REkn8+IgOMLoMmnRn6z3sljQj2/XKtqijfXnQFiNU7a26OmCI6OkUZj0eIUN2P1RvIJ1Bs=</Modulus
><Exponent>AQAB</Exponent></RSAKeyValue></KeyValue><msrel:RelData
xmlns:msrel=“http://schemas.microsoft.com/windows/rel/2005/reldata”><r:license
xmlns:r=“urn:mpeg:mpeg21:2003:01-REL-R-NS”
xmlns:as=“http://schemas.microsoft.com/windows/pki/2005/Authenticode”><r:grant
><as:ManifestInformation Hash=“5841394ce65f5535d8134ddbb27b2334e03b8f11”
Description=“” Url=“”><as:assemblyIdentity name=“Tooth_Ferry.application”
version=“1.0.3.4” publicKeyToken=“6330b9f96e1e8647” language=“en”
processorArchitecture=“msil” xmlns=“urn:schemas-microsoft-com:asm.v1”
/></as:ManifestInformation><as:SignedBy
/><as:AuthenticodePublisher><as:X509SubjectName>CN=HQBCI2000\BlanchardK</as:X
509SubjectName></as:Authenticodepublisher></r:grant><r:issuer><Signature
Id=“AuthenticodeSignature”
xmlns=“http://www.w3.org/2000/09/xmldsig#”><SignedInfo><CanonicalizationMethod
Algorithm=“http://www.w3.org/2001/10/xml-exc-c14n#” /><SignatureMethod
Algorithm=“http://www.w3.org/2000/09/xmldsig#rsa-sha1” /><Reference
URI=“”><Transforms><Transform
Algorithm=“http://www.w3.org/2000/09/xmldsig#enveloped-signature”
/><Transform Algorithm=“http://www.w3.org/2001/10/xml-exc-c14n#”
/></Transforms><DigestMethod
Algorithm=“http://www.w3.org/2000/09/xmldsig#sha1”
/><DigestValue>pkvb4XwiZQxOnuxM4AdLssHDSVg=</DigestValue></Reference></Signed
Info><SignatureValue>an+E413sMTw9Yh6tB3Pf0oFaFi6OMxIV0SNqT1/nfDt01s6K7d5zQZXX
bHC7ZQPsOKaSGH2TRCps17IQ20gc1wrZmkfg/eiNrY7sZz+IVqI+JADRgZ7p5z7wI/m6sW+Thvz3u
3M5vm1NgDFu2b2GstNJauxq96CQzPQBhKMlNdY=</SignatureValue><KeyInfo><KeyValue><R
SAKeyValue><Modulus>qegkjXEG7IIat9mIoYVk8Jl5XZOpkoc6cxEG58g581eXiquaF0hyLZ87t
8AahnJZ2SrpoWjytx9eR8hZSRNTIX0v0ICjrx1GDA7R7REkn8+IgOMLoMmnRn6z3sljQj2/XKtqij
fXnQFiNU7a26OmCI6OkUZj0eIUN2P1RvIJ1Bs=</Modulus><Exponent>AQAB</Exponent></RS
AKeyValue></KeyValue><X509Data><X509Certificate>MIIB4TCCAU6gAwIBAgIQaBZ0f4f4b
LVJYraTZ9Y1izAJBgUrDgMCHQUAMDMxMTAvBgNVBAMeKABIAFEAQgBDAEkAMgAwADAAMABcAEIAbA
BhAG4AYwBoAGEAcgBkAEswHhcNMDUwOTIxMDQ1MDAzWhcNMDYwOTIxMTA1MDAzWjAzMTEwLwYDVQQ
DHigASABRAEIAQwBJADIAMAAwADAAXABCAGwAYQBuAGMAaABhAHIAZABLMIGfMA0GCSqGSIb3DQEB
AQUAA4GNADCBiQKBgQCp6CSNcQbsghq32YihhWTWmX1dk6mShzpzEQbnyDnzV5eKq5oXSHItnzu3w
BqGclnZKumhaPK3H15HyF1JE1MhfS/QgKOvHUYMDtHtESSfz4iA4wugyadGfrPeyWNCPb9cq2qKN9
edAWI1Ttrbo6YIjo6RRmPR4hQ3Y/VG8gnUGwIDAQABMAkGBSsOAwIdBQADgYEAeccefLeuoPEh9KP
N1GmdKOEP6P7QblvdDJ8SwTI2qsW/crZcqun4pBJNsscUsvYdGpoDOR8IuIHh6NOjzhQ2X4vl3sJE
HUro9HO0OmSvtlIhzhxnBVUL63Kht0BwGZjg9e4+PnJupBoTk5YysVsG4afUwjr0SCZaEkspMguXd
1E=</X509Certificate></X509Data></KeyInfo></Signature></r:issuer></r:license>
</msrel:RelData></KeyInfo></Signature></asmv1:assembly>
```

What we claim is:

1. A method of storing and reading personal information of a person, comprising:
(a) securing a RF read-write chip to at least one tooth of a specific person;
(b) storing specific personal information about that specific person on said RF read-write chip;
(c) reading said specific personal information via an RF reader when the specific person is brought into close proximity to said RF reader;
(d) repeating said step (b);
(e) said step (d) comprising re-writing said RF read-write chip with revised specific personal information at least partially different from the specific personal information of said step (b); and
(f) repeating said step (c) for reading the revised specific personal information of said step (e).

2. The method of storing and reading personal information of a person according to claim 1, wherein said specific personal information comprises personal medical information for said specific person.

3. The method of storing and reading personal information of a person according to claim 2, wherein said personal medical information comprises at least one of: drug information; allergy information; past surgical history information; anesthesia-related problem information; lab value information; baseline EKG information; physical examination information; contact information; insurance information; date of birth; sex; height; weight; and family history information.

4. The method of storing and reading personal information of a person according to claim 1, wherein said step (a) comprises one of: bonding said RF read-write chip to the at least one tooth; implanting said RF read-write chip to the at least one tooth; and securing said RF read-write chip to a crown and bonding said crown to the at least one tooth.

5. The method of storing and reading personal information of a person according to claim 1, wherein said step (a) comprises securing a RF read-write chip of a size of approximately six by six mm.

6. The method of storing and reading personal information of a person according to claim 1, wherein said step (b) is performed before said step (a), and said step (d) is performed after said step (a).

7. A method of storing and reading personal medical information of a person, comprising:
(a) bonding a RF read-write tag to at least one tooth of a specific person;
(b) storing specific personal medical information about said specific person on said RF read-write tag;
(c) reading said specific personal medical information via an RF proximity reader when said specific person is brought into close proximity to said proximity reader;
(d) repeating said step (b);
(e) said step (d) comprising re-writing said RF read-write tag with revised specific personal medical information at least partially different from the specific personal information of said step (b); and
(f) repeating said step (c) for reading the revised specific personal medical information of said step (e).
